(19) United States
(12) Patent Application Publication
(10) Pub. No.: US 2022/0126276 A1
(43) Pub. Date: Apr. 28, 2022

(54) CATALYST FOR AMMONIA SYNTHESIS AND METHOD FOR SYNTHESIZING AMMONIA USING THE SAME

(71) Applicant: TOKYO INSTITUTE OF TECHNOLOGY, Tokyo (JP)

(72) Inventors: Michikazu HARA, Tokyo (JP); Hideo HOSONO, Tokyo (JP); Masashi HATTORI, Tokyo (JP)

(73) Assignee: TOKYO INSTITUTE OF TECHNOLOGY

(21) Appl. No.: 17/506,751

(22) Filed: Oct. 21, 2021

(30) Foreign Application Priority Data
Oct. 26, 2020 (JP) 2020-179192

(51) Int. Cl. B01J 23/46; C01C 1/04; B01J 31/12; B01J 27/12

(52) U.S. Cl. CPC B01J 23/462; B01J 27/12; B01J 31/121; C01C 1/0411

(57) ABSTRACT

The invention provides a catalyst for ammonia synthesis which has a high ammonia synthesis activity even at a low reaction temperature and a low reaction pressure and shows no decrease in the catalytic activity even when the synthesis reaction is repeated. The catalyst for ammonia synthesis comprises a metal supported material containing a transition metal and a support for supporting the transition metal. The support contains a metal hydride represented by XHₙ and an F ion. In the formula, X represents at least one kind selected from the group consisting of atoms of Group 2 and Group 3 of the periodic table, and lanthanoid atoms; and n represents a number represented by 2≤n≤3.

### TECHNICAL FIELD

The invention provides a catalyst for ammonia synthesis and a method for synthesizing ammonia using the catalyst.

The present application claims priority under Japanese Patent Application No. 2020-179192 filed on Oct. 26, 2020, the contents of which are incorporated herein.

### BACKGROUND

As a typical ammonia synthesis method, the Haber-Bosch method uses a doubly promoted iron catalyst containing several percent by mass of Al₂O₃ and K₂O in Fe₃O₄ as a catalyst, and brings a mixed gas of nitrogen and hydrogen into contact with the catalyst under high temperature and high pressure conditions to produce ammonia. This technology is widely used industrially in the production process as almost the same as it was completed.

On the other hand, a method of synthesizing ammonia at a temperature lower than the reaction temperature of the Haber-Bosch method has been studied. Catalysts capable of synthesizing ammonia by contacting with nitrogen and hydrogen have been investigated, and transition metals have been studied as their catalytically active components. Among them, a method using ruthenium (Ru) as a catalyst active component on various catalyst supports and using it as a catalyst for ammonia synthesis has been proposed as an efficient method (for example, Patent Document 1).

Since the catalyst using a transition metal such as Ru has a very high activity, it is known that ammonia can be synthesized under milder conditions than those used in the Haber Bosch method. At low temperatures and low pressures, for example, at a reaction temperature of 200° C. to 400° C. and a reaction pressure from atmospheric pressure to about 1.1 MPa, it is known that the reaction can proceed.

A calcium aluminosilicate composed of CaO, Al₂O₃, and SiO₂ has a crystal structure similar to that of mayenite and is called a “mayenite type compound”. The mayenite type compound has a structure in which a representative composition thereof is represented by 12CaO.7Al₂O₃ and two oxygen atoms are included as “free oxygen” in a space of a cage formed by the crystal skeleton.

The present inventors have found that a catalyst in which a transition metal is supported as a catalytic active component on a mayenite compound (hereinafter referred to as C12A7 electride) in which a free oxygen in the mayenite type compound is substituted by an electron has high activity as a catalyst for ammonia synthesis (Patent Document 2).

Further, the present inventors have found that a supported metal catalyst using a metal amide compound, a metal hydride; and a supported metal catalyst containing a metal hydride, an alkaline earth metal oxide, and a supported metal catalyst have high activity as a catalyst for ammonia synthesis (Patent Documents 3 to 5).

These catalysts have sufficient reaction activity even under reaction conditions of low temperature and low pressure in comparison with the reaction condition of the Harber-Bosch method.

### PATENT DOCUMENTS

[Patent Document 1] Japanese Unexamined Patent Application Publication No. 2006-231229

[Patent Document 2] WO 2012/077658

[Patent Document 3] WO 2016/088896

[Patent Document 4] WO 2017/082265

[Patent Document 5] Japanese Unexamined Patent Application Publication No. 2019-126776

### SUMMARY OF INVENTION

### Problems to be Solved by the Invention

Although the ammonia synthesis by the Haber-Bosch method using a doubly promoted iron catalyst has been put into practical use, it requires a high temperature and pressure condition. Therefore, there is a problem that the burden on an apparatus and the cost is high.

The supported metal catalyst as disclosed in Patent Document 1 uses a carbonaceous support such as activated carbon or an inorganic oxide support. However, the supported metal catalysts have a low reaction activity and has an insufficient performance for practical use.

That is, a catalyst for ammonia synthesis having a sufficient reactivity even under a condition of lower temperature and lower pressure, than the reaction conditions of the Haber-Bosch method, is required.

Although the catalysts as disclosed in Patent Documents 2 to 3 have sufficient reaction activity even under reaction conditions of low temperature and low pressure, there is a need for a catalyst for ammonia synthesis having a high reaction activity, which can be produced by a simpler method than these catalysts.

The catalysts disclosed in Patent Documents 4 and 5 can be produced by a simpler method than the catalyst disclosed in Patent Documents 2 to 3, while having sufficient reaction activity even under reaction conditions of low temperature and low pressure, but there is a need for a catalyst for ammonia synthesis which maintains the catalytic activity even if the synthesis reaction is repeated for a long time.

### Means for Solving Problems

The present inventors have found a catalyst for ammonia synthesis of the present invention, which can achieve both improvement and stabilization of catalyst performance at a low temperature by loading a transition metal on a support containing a fluorine ion (F ion) and a metal hydride.

That is, the subject matter of the present invention is:

[1] A catalyst for ammonia synthesis, comprising:

a metal supported material which comprises
a transition metal, and
a support for supporting the transition metal,

wherein the support comprises:
a metal hydride represented by the following general formula (1), and an F ion,

XHₙ (1)

wherein in the general formula (1), X represents at least one kind selected from the group consisting of atoms of Group 2 of the periodic table, atoms of Group 3 of the periodic table, and lanthanoid atoms; and n represents a number represented by 2≤n≤3.

[2] The catalyst for ammonia synthesis according to [1],

wherein the support comprises an F ion-substituted metal hydride obtained by substituting at least a part of a hydrogen anion of the metal hydride with an F ion.

[3] The catalyst for ammonia synthesis according to [1],

wherein the support comprises

the metal hydride, and

a metal fluoride represented by the following general formula (2),

YFₘ (2)

wherein in the general formula (2), Y represents at least one kind selected from the group consisting of atoms of Group 2 of the periodic table, atoms of Group 3 of the periodic table, and lanthanoid atoms; and m represents a number represented by 2≤m≤3.

[4] The catalyst for ammonia synthesis according to [3],

wherein Y in the general formula (2) is at least one selected from the group consisting of Mg, Ca, Sr, Ba, Sc, Y, and lanthanoid atoms.

[5] The catalyst for ammonia synthesis according to any one of [1] to [4],

wherein X in the general formula (1) is at least one selected from the group consisting of Mg, Ca, Sr, Ba, Sc, Y, and lanthanoid atoms.

[6] The catalyst for ammonia synthesis according to any one of [1] to [5],

wherein the transition metal is at least one selected from the group consisting of Ru, Co, and Fe.

[7] The catalyst for ammonia synthesis according to any one of [1] to [6],

wherein an amount of the transition metal supported on the support is 1.0% by mass or more and 30% by mass or less.

[8] The catalyst for ammonia synthesis according to one of [1] to [7],

wherein an amount of the F ion with respect to the total mole number of the metal hydride and the F ion is 0.5 mol % or more and 20 mol % or less.

[9] A method for synthesizing ammonia, the method comprising:

bringing a raw material gas containing hydrogen and nitrogen into contact with the catalyst according to claim 1 to synthesize ammonia.

[10] The method for synthesizing ammonia according to [9],

wherein a reaction temperature in contact with the catalyst for ammonia synthesis is 200° C. or more and 600° C. or less.

[11] The method for synthesizing ammonia according to [9] or [10],

wherein a reaction pressure in contact with the catalyst for ammonia synthesis is 10 kPa or more and 20 MPa or less.

[12] The method for synthesizing ammonia according to any one of [9] to [11], wherein a water content of the raw material gas is 100 ppm or less.

[13] The method for synthesizing ammonia according to any one of [9] to [12],

wherein a ratio of hydrogen to nitrogen (H₂/N₂ (volume/volume)) in contact with the catalyst for ammonia synthesis is 0.4 or more.

### Effect of the Invention

The catalyst for ammonia synthesis has a high ammonia synthesis activity even at a low reaction temperature and a low reaction pressure, and is suitable used as a catalyst for ammonia synthesis because the catalyst activity does not decrease even if the synthesis reaction is continued for a long time. Ammonia can be synthesized with less energy by synthesizing ammonia using the catalyst for ammonia synthesis, and ammonia can be synthesized with high efficiency and chemical stability for a long period of time because the catalyst activity does not decrease even if the synthesis reaction is continued for a long time. That is, the catalyst for ammonia synthesis of the present invention is characterized in that the catalyst performance can be improved and stabilized at the same time, and the catalyst performance does not deteriorate with time.

### BRIEF DESCRIPTION OF DRAWINGS

FIG. 1 is a graph showing the ammonia formation rate over time in Example 1 and Comparative Example 1.

FIG. 2 is a graph showing the ammonia formation rate over time in Examples 2 to 4.

FIG. 3 shows the molar ratio dependence of catalytic activity (ammonia formation rate) on BaF₂.

FIG. 4 shows the X-ray diffraction pattern of the ammonia synthesis catalyst support in Example 6.

FIG. 5 is an SEM photograph of the ammonia synthesis catalyst support in Example 6 prior to heating in hydrogen.

FIG. 6 is an SEM photograph of the ammonia synthesis catalyst support in Example 6 after heat treatment in hydrogen.

FIG. 7 is a graph showing the ammonia formation rate at each temperature in Example 5.

### DESCRIPTION OF THE INVENTION

The present invention will now be described in detail.

<Catalyst for Ammonia Synthesis>

The catalyst for ammonia synthesis comprises a transition metal and a support for supporting the transition metal. The support contains a metal hydride represented by the following general formula (1) and an F ion.

XHₙ (1)

In the above general formula (1), X represents at least one kind selected from the group consisting of Group 2 atoms of the periodic table, Group 3 atoms of the periodic table, and lanthanoid atoms; n represents a number expressed by 2≤n≤3.

In the support, the molar ratio content of the F ion is not particularly limited, but the content of the F ion with respect to the total number of moles of the metal hydride and the F ion is usually 0.5 mol % or more, preferably 1.0 mol % or more, more preferably 1.5 mol % or more, usually 20 mol % or less, preferably 10 mol % or less, and more preferably 5 mol % or less. If the value is equal to or higher than the lower limit value, the effect of the present invention can be obtained. When the value is equal to or less than the upper limit value, the catalytic activity is reduced.

(Metal Hydride)

The support used in the present invention includes a hydride of a metal element X.

In the general formula (1), X represents at least one kind selected from the group consisting of atoms of Group 2 and Group 3 of the periodic table, and lanthanoid atoms.

The atom used for X is not particularly limited, but may contain one kind or two or more kinds of elements. When two or more kinds of elements are contained, it is preferable that the two or more kinds of elements are in the same Group of the periodic table, or the two or more kinds of elements are lanthanoid atoms, though not particularly limited.

The Group 2 atom of the periodic table (hereinafter, simply referred to as Group 2 atom and sometimes abbreviated as AE) is not particularly limited, and is preferably Mg, Ca, Sr, or Ba. It is more preferably Ca, or Sr because of its high activity when used as a catalyst for ammonia synthesis. And it is still more preferably Ca because of its high activity when used as a catalyst for ammonia synthesis.

The Group 3 atom of the periodic table (hereinafter referred to as Group 3 atom.) is not particularly limited, but is preferably Y because it is an element having a larger abundance.

The lanthanoid atom is not particularly limited, but is preferably La, Ce, Pr, Nd, Sm, Eu, Pr, or Yb because they are more general materials. It is more preferably La, Ce, Nd or Sm in relatively large abundance. And it is still more preferably La or Ce because of its high activity when used as a catalyst for ammonia synthesis.

If X is a lanthanoid atom, it may include a plurality of lanthanoid atoms, specifically, it may be a Misch Metal. The Misch Metal is a common name of an alloy containing a plurality of rare earth elements, and is generally known as an alloy containing a large amount of Ce as a component thereof.

Hereinafter, the Group 3 atoms and lanthanoid atoms may be collectively referred to as RE.

The X is preferably a Group 2 atom or a lanthanoid atom which have a large abundance and high activity when used as a catalyst for ammonia synthesis; and is more preferably a Group 2 atom in terms of a large abundance.

The X is preferably Ca, Mg, Sr, Ba, Y or a lanthanoid atom. It is more preferably Ca, Mg, Sr, Ba, Y, La, Ce, Pr, Nd, Sm, Eu, Pr or Yb. And it is still more preferably Ca.

In the general formula (1), n represents a numerical value of 2≤n≤3.

When X is a Group 2 atom, the above-mentioned n is not particularly limited, but is preferably 2.

When X is a Group 3 atom or a lanthanoid atom, n usually represents any value from 2 to 3, and is preferably 2 or 3.

The AE and the RE usually form an ion-bonded hydride. In ion-bonded hydrides, hydrogen exists as a hydride ion (H⁻ ion), which forms hydrogen (H₂) and hydroxide ion (OH⁻) upon contact with water or acid.

As the hydride of RE (hereinafter referred to as REHₙ), a dihydride which is a general hydride and a trihydride which is a high density hydride are known. A high density metal hydride having a value between the dihydride and the trihydride can then be formed, and a value between the dihydride and the trihydride can be continuously varied.

The aforementioned X may further contain atoms other than X, specifically at least one kind of alkali metal atom, as long as the effect of the present invention is not impaired.

The metal hydride used in the present invention is not particularly limited, and a commercially available reagent and an industrial material may be used, or may be synthesized by a known method such as heating the corresponding metal in a hydrogen atmosphere.

Typically, the metal hydride is obtained by heating the corresponding metal in a hydrogen atmosphere. For example, calcium hydride (CaH₂) is obtained by heating metallic calcium in a hydrogen atmosphere at about 400° C. For example, cerium hydride (CeH₂) is obtained by heating metallic cerium in a hydrogen atmosphere at about 700° C. to 800° C.

(F Ion)

An F ion can be introduced by using, for example, a metal fluoride represented by general formula (2).

YFₘ (2)

In the above general formula (2), Y represents at least one kind selected from the group consisting of Group 2 atoms of the periodic table, Group 3 atoms of the periodic table, and lanthanoid atoms; m represents a number expressed as 2≤m≤3.

The metal fluoride represented by the general formula (2) is preferably an alkali metal fluoride or an alkaline earth metal fluoride. For example, the support can be obtained by partially converting CaH₂ to CaFH by heating a mixture of CaF₂ and CaH₂, or a mixture of BaF₂ and CaH₂ in hydrogen at 340° C. for 10 hours. As the metal fluoride, one kind or a plurality of metal fluorides selected from the group consisting of an alkaline earth metal fluorides, and alkali metal fluoride can be used.

(Transition Metal)

As the transition metal used in the present embodiment, it is not particularly limited, but transition metals from Groups 6, 7, 8, 9, or 10 of the periodic table may be used, preferably those from Groups 6, 8, or 9 may be used, and more preferably those from Groups 8 or 9 may be used.

As the specific metal element, it is not particularly limited, but Cr, Mo, Mn, Re, Fe, Ru, Os, Co, Rh, Ni, Pd, or Pt may be used. Mo, Re, Fe, Ru, Os, or Co may be used preferably in view of high bonding energy with nitrogen. Ru, Co, or Fe may be used more preferably in view of catalytic activity on synthesizing ammonia when supported metal material is used as a supported metal catalyst. And, Ru may be used most preferably in view of the highest catalytic activity.

Each of the above elements may be used alone, or two or more of them may be used in combination. Intermetallic compounds of these elements such as Co₃Mo₃N, Fe₃Mo₃N, Ni₂Mo₃N, Mo₂N and the like may also be used. Each element may be used alone or in combination of two or more kinds; and preferably, each element may be used alone in view of cost.

(Composition of Catalyst for Ammonia Synthesis)

In the catalyst for ammonia synthesis of the present invention, the loading amount of the transition metal supported on the support is not particularly limited, but is usually 0.5% by mass or more, preferably 2% by mass or more, more preferably 5% by mass or more, usually 20% by mass or less, preferably 15% by mass or less, and more preferably not more than 10% by mass or less with respect to the total amount of the catalyst. When the value is equal to or larger than the lower limit value, the effect of the present invention can be obtained, and when the value is equal to or smaller than the upper limit value, the effect of the present invention can be obtained in proportion to the loading amount and the cost.

The specific surface area of the catalyst for ammonia synthesis of the present invention is not particularly limited, but is usually 0.1 m²/g or more, preferably 1 m²/g or more, and more preferably 3 m²/g or more.

(Shape of Catalyst for Ammonia Synthesis)

A shape of the catalyst for ammonia synthesis of the present embodiment is not particularly limited, and may be in any shape such as lump, powder, coating, etc., but preferably it may be powder. The particle size of the supported metal material powder is not particularly limited, but it may be 1 nm to 10 μm.

The particle diameter of the transition metal in the catalyst for ammonia synthesis of the present embodiment is not particularly limited, but it may be 1 nm or more and 100 nm or less. It is preferably 10 nm or less, and more preferably 5 nm or less in view of increasing the number of step sites, which is the active point of nitrogen dissociation when the supported metal material is used as a catalyst for ammonia synthesis.

The degree of dispersion of the alkaline earth metal oxide in the support of the catalyst for ammonia synthesis of the present invention is not particularly limited, but for example, an alkaline earth metal oxide particle (region) in the support is usually 10 nm or more and 20 um or less. It is desirable that an alkaline earth metal oxide is dispersed on the surface of the catalyst for ammonia synthesis, but it is not desirable to completely cover the surface.

(Method for Producing Catalyst for Ammonia Synthesis)

A catalyst for ammonia synthesis is produced by loading a transition metal on the support. The producing method is not particularly limited, but the catalyst for ammonia synthesis is usually produced by loading a transition metal or a compound to be a precursor of the transition metal (hereinafter, the transition metal compound) on the support.

The method for producing the catalyst for ammonia synthesis of the present invention is not particularly limited, and a known method can be used. Specifically, a physical mixing method, a CVD method (chemical vapor deposition), a sputtering method, or the like can be used. Since the support contained in the catalyst for ammonia synthesis contains a metal hydride, the support is easy to react with water and has low solubility in an organic solvent. Therefore, as a method of loading the transition metal on the support, a physical mixing method is preferable. In the physical mixing method, the support and the transition metal compound are mixed in a solid state and then heated in an inert gas stream such as nitrogen, argon, helium or under vacuum. As the mixing method in a solid state, for example, a known apparatus and method for mixing and pulverizing two or more kinds of solids can be used. In this case, a heating temperature is usually preferably not less than the decomposition temperature of the transition metal compound and not more than 400° C. The heating time is preferably 2 hours or more.

The support thus obtained may be used as it is to support the transition metal in a transition metal supporting step described later. Alternatively, a pre-treatment for heating in a hydrogen atmosphere at about 200 to 500° C. for several hours, for example, at 340° C. for 2 hours, may be performed, and then the transition metal may be loaded in a transition metal supporting step described later.

For example, when the catalyst, which is produced by using a sample in which the support is previously heated in a hydrogen atmosphere, is used in an ammonia synthesis reaction, a high activity can be obtained immediately after the start of the reaction.

The method of loading a transition metal on the support used in the present embodiment is not particularly limited, and known methods can be used. Generally, a method is used in which a transition metal compound which is a compound of a supported transition metal and can be converted into a transition metal by reduction, thermal decomposition, or the like is supported on the support and then converted into a transition metal.

As the transition metal compound, it is not particularly limited, but an inorganic compound or an organic transition metal complex of a transition metal easily susceptible to thermal decomposition or the like may be used. Specifically, a complex of transition metal, an oxide of transition metal, a transition metal salt such as a nitrate and a hydrochloride, or the like may be used.

For example, as a Ru compound, triruthenium dodecacarbonyl[Ru₃(CO)₁₂], dichloro tetrakis (triphenylphosphine) ruthenium (II)[RuCl₂(PPh₃)₄], dichloro-tris (triphenylphosphine) ruthenium (II)[RuCl₂(PPh₃)₃], tris (acetylacetonato) ruthenium (III)[Ru(acac)₃], ruthenocene [Ru(C₅H₅)], nitrosyl ruthenium nitrate [Ru(NO)(NO₃)₃], potassium ruthenate, ruthenium oxide, ruthenium nitrate, ruthenium chloride, or the like may be used. Tris (acetylacetonato) ruthenium (III)[Ru(acac)₃] is preferable.

As an Fe compound, iron pentacarbonyl [Fe(CO)₅], dodecacarbonyl ferric [Fe₃(CO)₁₂], nona carbonyl iron [Fe₂(CO)₉], tetracarbonyl iron iodide [Fe(CO)₄I₂], tris (acetylacetonato) iron(III) [Fe(acac)₃], ferrocene [Fe(C₅H₅)₂], iron oxide, iron nitrate, iron chloride(FeCl₃), etc.), or the like may be used.

As a Co compound, cobalt octacarbonyl [Co₂(CO)₈], tris (acetylacetonato) cobalt (III)[Co(acac)₃], cobalt (II) acetylacetonate [Co(acac)₂], cobaltocene [Co(C₅H₅)₂], cobalt oxide, cobalt nitrate, cobalt chloride, or the like may be used.

A carbonyl complex of transition metal such as [Ru₃(CO)₁₂], [Fe(CO)₅], [Fe₃(CO)₁₂], [Fe₂(CO)₉], or [Co₂(CO)₈] among these transition metal compounds is preferable in view that the reduction treatment to be described later can be omitted in the production of the supported metal material of the present embodiment because the transition metal may be loaded by loading the carbonyl complex and then heating it.

The loading amount of the transition metal compound to be used is not particularly limited, and an amount for realizing a desired loading amount can be suitably used, but normally, the amount is usually 2% by mass or more, preferably 10% by mass or more, more preferably 20% by mass or more, usually 50% by mass or less, preferably 40% by mass or less, and more preferably 30% by mass or less with respect to the weight of the support to be used.

As the method for loading the transition metal compound on the support, for example, a physical mixing method, a CVD method (chemical vapor deposition method), a sputtering method, or the like can be used.

In the physical mixing method, the support and the transition metal compound are mixed in a solid state and then heated in an inert gas stream such as nitrogen, argon, helium or under vacuum. A heating temperature at this time is not particularly limited, but is usually 200° C. or higher and 600° C. or lower. A heating time is not particularly limited, but usually 2 hours or more is desirable.

When a transition metal compound which may be converted to a transition metal by thermal decomposition is used, at this stage, a transition metal is loaded and it becomes the supported metal material of the present embodiment.

In the case of using a transition metal compound other than the above-mentioned transition metal compound which may be converted to a transition metal by thermal decomposition, a transition metal compound may be reduced to obtain the supported metal material of the present invention.

A method of reducing the transition metal compound (hereinafter referred to as “reduction treatment”) is not particularly limited as long as it does not disturb the object of the present invention, and examples thereof include a method in which the transition metal compound is reduced in a gas atmosphere containing a reducing gas, and a method in which a reducing agent such as NaBH₄, NH₂NH₂ or formalin is added to the solution of the transition metal compound to precipitate the transition metal on the surface of the metal hydride. However, the method in which the transition metal compound is reduced in a gas atmosphere containing a reducing gas is preferable. Examples of the reducing gas include hydrogen, ammonia, methanol (vapor), ethanol (vapor), methane, ethane and the like.

During the reduction treatment, a component other than the reducing gas which does not inhibit the object of the present invention, particularly the ammonia synthesis reaction, may coexist with the reaction system. Specifically, at the time of the reduction treatment, in addition to the reducing gas such as hydrogen, a gas such as argon or nitrogen which does not inhibit the reaction may be allowed to coexist, and nitrogen is preferably allowed to coexist.

When the reduction treatment is carried out in a gas containing hydrogen, it can be carried out in parallel with the production of ammonia to be described later by allowing nitrogen to coexist with hydrogen. That is, when the supported metal material of the present embodiment is used as a catalyst for ammonia synthesis described later, by placing the transition metal compound supported on the metal hydride in the reaction conditions of the ammonia synthesis reaction, the transition metal compound may be reduced and converted to the transition metal.

The temperature during the reduction treatment is not particularly limited, and it may be 200° C. or higher, preferably 300° C. or higher, and may be 600° C. or less. When the reduction treatment is carried out within the above reduction treatment temperature range, the growth of the transition metal occurs sufficiently and within a preferable temperature range.

A pressure during the reduction treatment is not particularly limited, but it may be 0.01 to 10 MPa. When the pressure during the reduction treatment is set to the same condition as the ammonia synthesis condition described later, since complicated operations are unnecessary, the pressure range is preferable in view of production efficiency.

A time of the reduction treatment is not particularly limited, but in the case where the reduction treatment is carried out under normal pressure, it may be 1 hour or more, and preferably 2 hours or more.

When the reaction is carried out at a high reaction pressure, for example, 1 MPa or more, it is preferable that the reaction is carried out for 1 hour or more.

When a transition metal compound other than a transition metal compound converted to a transition metal by thermal decomposition is used, the transition metal compound contained in the solid mixture is reduced by a normal method, as in the aforementioned reduction treatment method, thereby providing the catalyst for ammonia synthesis of the present embodiment.

As components other than the metal hydride and the transition metal, the support of the catalyst may further contain SiO₂, Al₂O₃, ZrO₂, MgO, activated carbon, graphite, SiC or the like.

The catalyst for ammonia synthesis of the present embodiment can be used as a molded body using a conventional molding technique. As a shape of the catalyst, for example, a shape such as granular, spherical, tablet, ring, macaroni, four leaves, dice, honeycomb, and the like can be used. It can also be used after coating a suitable support.

When the catalyst for ammonia synthesis of the present invention is used, the reaction activity is not particularly limited, but when the formation rate of ammonia at a reaction temperature of 340° C. and a reaction pressure of 0.1 MPa is taken as an example, the reaction activity is preferably 1.0 mmol g⁻¹ h⁻¹ or more, more preferably 3.0 mmol g⁻¹ h⁻¹ or more because it is suitable for practical production conditions, still more preferably 5.0 mmol g⁻¹ h⁻¹ or more because it is suitable for high-efficiency production conditions, and most preferably 10.0 mmol g⁻¹ h⁻¹ or more because it is more suitable for high-efficiency production conditions.

<Method for Synthesizing Ammonia>

The method for synthesizing ammonia of the present invention (hereinafter, may be refer to the synthesis method of the present invention.) is a method for synthesizing ammonia by reacting hydrogen with nitrogen on a catalyst which uses the catalyst for ammonia synthesis of the present invention.

As a specific synthesis method, it is not particularly limited, and ammonia can be appropriately produced according to a known synthesis method, as long as ammonia is synthesized by bringing hydrogen and nitrogen into contact with each other on the catalyst.

In the method for synthesizing ammonia of the present embodiment, usually, when hydrogen and nitrogen are brought into contact with each other on the catalyst, the catalyst is heated to produce ammonia.

The reaction temperature in the synthesis method of the present embodiment is not particularly limited, but is usually 50° C. or higher, preferably 200° C. or higher, more preferably 300° C. or higher, usually 600° C. or lower, preferably 500° C. or lower, and more preferably 450° C. or lower. Since ammonia synthesis is an exothermic reaction, although a lower temperature range is chemically advantageous for ammonia synthesis, it is preferable to carry out the reaction in the above temperature range in order to obtain a sufficient ammonia formation rate.

In the synthesis method of the present embodiment, the molar ratio of nitrogen and hydrogen brought into contact with the catalyst is not particularly limited, but usually the ratio of hydrogen to nitrogen (H₂/N₂ (volume/volume)) is 0.4 or more, preferably 0.5 or more, more preferably 1 or more, usually 10 or less, and preferably 5 or less.

The reaction pressure in the synthesis method of the present embodiment is not particularly limited, but is usually 0.01 MPa or more, preferably 0.1 MPa or more, usually 20 MPa or less, preferably 15 MPa or less, and more preferably 10 MPa or less at the pressure of the mixed gas containing nitrogen and hydrogen. For practical use, the reaction is preferably carried out under a pressurized condition of atmospheric pressure or higher.

In the synthesis method of the present embodiment, it is preferable to remove moisture or oxide adhering to the catalyst by using a dehydrating material, a cryogenic separation method, or hydrogen gas before bringing nitrogen and hydrogen into contact with the catalyst. The removal method includes reduction treatment.

In the synthesis method of the present embodiment, in order to obtain a better ammonia yield, it is not particularly limited but the water content in nitrogen and the water content in hydrogen used in the synthesis method of the present embodiment are preferably small, and the total water content in the mixed gas of nitrogen and hydrogen is usually preferably 100 ppm or less, preferably 50 ppm or less.

In the synthesis method of the present embodiment, the type of the reaction vessel is not particularly limited, and a reaction vessel which can be normally used for the ammonia synthesis reaction can be used. As a specific reaction form, for example, a batch type reaction form, a closed circulation system reaction form, a flow system reaction form, and the like can be used. From a practical viewpoint, a flow reaction type is preferable. Any of the following methods can be used: a method for connecting a single reactor filled with a catalyst or a plurality of reactors; or a method for using a reactor having a plurality of reaction layers in the same reactor.

Since the reaction for synthesizing ammonia from hydrogen and nitrogen is an exothermic reaction with volume shrinkage, heat of reaction is preferably removed industrially in order to increase the ammonia yield, and a known reactor with a commonly used heat removal means may be used. For example, a method may be used in which a plurality of reactors filled with a catalyst are connected in series and an intercooler is installed at the outlet of each reactor to remove heat.

In the ammonia synthesis method of the present invention, even if the catalyst for ammonia synthesis obtained by the synthesis method of the present invention is used alone, it can be used in combination with other known catalysts that can normally be used for ammonia synthesis.

Hereinafter, the catalyst for ammonia synthesis of the present invention will be described in detail using the first and second embodiments of the present invention, but the technical scope of the present invention is not limited thereto.

### First Embodiment

The catalyst for ammonia synthesis according to the first embodiment of the present invention is a metal supported material containing a transition metal and a support for supporting the transition metal. The support contains an F ion-substituted metal hydride obtained by substituting at least a part of hydrogen anions (hydrides) of a metal hydride represented by general formula (1) with a fluorine ion (F ion).

(F Ion-Substituted Metal Hydride)

In the F-ion-substituted metal hydride according to the present embodiment, the molar ratio (F/H) of the F ion to the hydrogen anion is not particularly limited, but is preferably 0.1 to 0.9, more preferably 0.5 to 1.5, and still more preferably 0.8 to 1.2.

As the F ion-substituted metal hydride of the present embodiment, for example, when the metal X is Ca, calcium fluoride hydride (CaFH) can be used.

(Support Containing F Ion-Substituted Metal Hydride and Preparation Method)

The support according to the present embodiment may contain a metal hydride represented by the general formula (1). In this case, the F ion-substituted metal hydride and the metal hydride having no F ion may be the same type of metal hydride or different type of metal hydride. From the viewpoint of easy production, the same type of metal hydride is preferable. The F ion-substituted metal hydride may be one type or two or more types. Examples of the support according to the present embodiment include a support containing F ion-substituted CaH₂ and CaH₂ having no F ion; a support containing F ion-substituted CaH₂, CaH₂ having no F ion and BaH₂ having no F ion; and the like. Examples of the support include a support containing CaFH and CaH₂; a support containing CaFH, CaH₂ and BaH₂; and the like.

The method for producing the support according to the present embodiment comprises a mixing step of preparing a mixture of an F ion-substituted compound and a metal hydride represented by the general formula (1); a heating step of heat-treating the mixture in a hydrogen atmosphere, a vacuum or an inert atmosphere.

“Mixing Step”

In the mixing step, the mixing method is not particularly limited, and known methods can be used. Specifically, a physical mixing method, a CVD method (chemical vapor deposition), a sputtering method, or the like can be used. Since a metal hydride is used, the mixture is easy to react with water and has low solubility in organic solvents. For this reason, as the mixing method, it is preferable to use a physical mixing method in an arbitrary order. As the physical mixing method, a known apparatus and method for mixing and pulverizing two or more kinds of solids can be used. For example, a method of mixing a mixture in solid state by adding the fluoride to the metal hydride in an apparatus for solid mixing such as an agate mortar or a solid mixer can be used.

In the mixing step, it is preferable to mix the metal hydride represented by the general formula (1) with the metal fluoride represented by the following general formula (2).

YFₘ (2)

In the above general formula (2), Y represents at least one kind selected from the group consisting of Group 2 atoms of the periodic table, Group 3 atoms of the periodic table, and lanthanoid atoms; and m represents a number expressed as 2≤m≤3.

In the mixing step, the molar ratio content of the metal fluoride to the total number of moles of the metal fluoride and the fluoride ([YFₘ]/([YFₘ]+[XHₙ]) is not particularly limited. For example, when m=2, it is usually 0.25 mol % or more, preferably 0.5 mol % or more, more preferably 0.75 mol % or more; usually 10 mol % or less, preferably 5 mol % or less, and more preferably 2.5 mol % or less.

<Metal Fluoride>

The metal fluoride used in the present embodiment includes a fluoride of a metal element Y.

In the general formula (2), Y represents at least one kind selected from the group consisting of atoms of Group 2 of the periodic table, atoms of Group 3 of the periodic table, and lanthanoid atoms.

The atom used for Y is not particularly limited, but may contain one kind or two or more kinds of elements. When two or more kinds of elements are contained, it is preferable that the two or more kinds of elements are in the same Group of the periodic table, or the two or more kinds of elements are lanthanoid atoms, though not particularly limited.

The Group 2 atom of the periodic table (hereinafter, simply referred to as Group 2 atoms and sometimes abbreviated as AE.) is not particularly limited, but is preferably Mg, Ca, Sr, or Ba; more preferably Ca or Sr because of its high activity when used as a catalyst for ammonia synthesis; and still more preferably Ca because of its high activity when used as a catalyst for ammonia synthesis.

The Group 3 atom of the periodic table (hereinafter referred to as Group 3 atom.) is not particularly limited, but is preferably Y because it is an element having a larger abundance.

The lanthanoid atom is not particularly limited, but is preferably La, Ce, Pr, Nd, Sm, Eu, Pr, or Yb because it is a more versatile material. It is more preferably La, Ce, Nd or Sm in relatively large abundance. And it is still more preferably La or Ce because of its high activity when used as a catalyst for ammonia synthesis.

If Y is a lanthanoid atom, it may include a plurality of lanthanoid atoms, specifically, it may be a Misch Metal. The Misch Metal is a common name of an alloy containing a plurality of rare earth elements (rare earth elements), and is generally known as an alloy containing a large amount of Ce as a component thereof.

Hereinafter, the Group 3 atoms and lanthanoid atoms may be collectively referred to as RE.

The X is preferably a Group 2 atom or a lanthanoid atom having a large amount of an element and high activity when used as a catalyst for ammonia synthesis, and more preferably is a Group 2 atom in terms of a large amount of an element.

The Y is preferably Ca, Mg, Sr, Ba, Y or a lanthanoid atom, more preferably Ca, Mg, Sr, Ba, Y, La, Ce, Pr, Nd, Sm, Eu, Pr or Yb, and still more preferably Ba.

In the general formula (2), m represents a numerical value of 2≤m≤3.

When Y is a Group 2 atom, m is not particularly limited, but is preferably 2.

When Y is a Group 3 atom or a lanthanoid atom, m usually represents an arbitrary value of 2 to 3, preferably 2 or 3.

The AE and the RE usually form an ion-bonded fluoride. In the ion-bound fluoride, fluorine exists as an anion (F ion).

As the fluoride of RE (hereinafter referred to as REFₘ), a difluoride which is a general fluoride and a trifluoride which is a high-density hydride are known. A high density metal fluoride having a value between the difluoride and the trifluoride can be formed, and the value between the difluoride and the trifluoride can be continuously changed.

A part of Y may further contain an atom other than the Y, as long as the effect of the present invention is not impaired. Specifically, Y may contain at least one kind of alkali metal atom.

The metal fluoride used in the present invention is not particularly limited, and commercially available reagents and industrial raw materials can be used.

“Heating Step”

In the heating step, for example, a method of heating the mixture in an inert gas stream such as nitrogen, argon, helium, or the like; or under vacuum can be used. In this case, the heating temperature is usually preferably from 50° C. to 600° C., more preferably from 50° C. to 400° C. The heating time is preferably 2 hours or more.

The heating step may be performed before or after loading the transition metal compound on the support. In the case where the reaction is carried out after the support, it is desirable that the reaction temperature is not lower than the decomposition temperature of the transition metal compound and not higher than 400° C. The heating time is preferably 2 hours or more.

(Metal Hydride)

The metal hydride of the present embodiment and preferred embodiments thereof are the same as the “metal hydride” described above.

(Transition Metal)

The transition metal of the present embodiment and preferred embodiments thereof are the same as the “transition metal” described above.

(Composition of Catalyst for Ammonia Synthesis)

The composition of the catalyst for ammonia synthesis of the present embodiment and its preferable embodiment are the same as those of the “composition of the catalyst for ammonia synthesis” described above.

(Shape of Catalyst for Ammonia Synthesis)

The shape of the catalyst for ammonia synthesis of the present embodiment and its preferred embodiment are the same as the “shape of the catalyst for ammonia synthesis” described above.

(Method for Producing Catalyst for Ammonia Synthesis)

The method for producing the catalyst for ammonia synthesis of the present embodiment and a preferable embodiment thereof are the same as those of the “method for producing the catalyst for ammonia synthesis” described above.

In the method for preparing the support, when the heating step is performed after the catalyst for ammonia synthesis is prepared, the heating step for the mixture of the transition metal compound and the support may be set so as to satisfy the conditions of the heating step of the support.

<Method for Synthesizing Ammonia>

The method for synthesizing ammonia according to the present embodiment and preferred embodiments thereof are the same as those of the above-described “method for synthesizing ammonia”.

### Second Embodiment

The catalyst for ammonia synthesis according to the second embodiment is a metal supported material containing a transition metal and a support for supporting the transition metal, wherein the support contains a metal hydride represented by the general formula (1) and a metal fluoride represented by the following general formula (2).

YFₘ (2)

In the general formula (2), Y represents at least one kind selected from the group consisting of atoms of Group 2 of the periodic table, atoms of Group 3 of the periodic table, and lanthanoid atoms; and m represents a number represented by 2≤m≤3.

Examples of the support include a mixture containing CaH₂ and BaF₂.

<Metal Hydride>

The metal hydride of the present embodiment and preferred embodiments thereof are similar to the “metal hydride” described in the first embodiment.

<Metal Fluoride>

The metal fluoride of the present embodiment and preferred embodiments thereof are the same as the “metal fluoride” described in the first embodiment.

(Support Containing Metal Hydride and Metal Fluoride, and Preparation Method)

The support according to the present embodiment is a mixture of the metal hydride and the metal fluoride. In contrast to the support according to the first embodiment, the support is characterized in that it does not contain an F ion-substituted metal hydride. The method for preparing the support according to the present embodiment includes the same step as the mixing step of the first embodiment. In contrast to the method of preparing the support according to the first embodiment, the method of preparing the support according to the present embodiment is characterized in that it does not include a heating step of heating the mixture.

The molar ratio content of the metal fluoride to the total molar number of the metal fluoride and the metal hydride contained in the support ([YFₘ]/([YFₘ]+[XHₙ]) is not particularly limited. For example, when m=2, it is usually 0.25 mol % or more, preferably 0.5 mol % or more, more preferably 0.75 mol % or more, usually 10 mol % or less, preferably 5 mol % or less, and more preferably 2.5 mol % or less.

(Transition Metal)

The transition metal of the present embodiment and preferred embodiments thereof are the same as the “transition metal” described above.

(Composition of Catalyst for Ammonia Synthesis)

The composition of the catalyst for ammonia synthesis of the present embodiment and its preferable embodiment are the same as those of the “composition of the catalyst for ammonia synthesis” described above.

(Shape of Catalyst for Ammonia Synthesis)

The shape of the catalyst for ammonia synthesis of the present embodiment and its preferred embodiment are the same as the “shape of the catalyst for ammonia synthesis” described above.

(Method for Producing Catalyst for Ammonia Synthesis)

The method for producing the catalyst for ammonia synthesis of the present embodiment and a preferable embodiment thereof are the same as those of the “method for producing the catalyst for ammonia synthesis” described above.

The method for producing the catalyst for ammonia synthesis according to the present embodiment does not need to include the step of heat-treating the support as compared with the method for producing the first embodiment. That is, for example, when the transition metal compound is used, the heating temperature and the heating time for reducing the supported transition metal compound to the transition metal may be used.

<Method for Synthesizing Ammonia>

The method for synthesizing ammonia according to the present embodiment and preferred embodiments thereof are the same as the steps described in the above-mentioned “Method for Synthesizing Ammonia”.

Since the catalyst for ammonia synthesis of the present embodiment does not contain the F ion-substituted metal hydride, the reaction rate is slow in the initial stage of ammonia synthesis. In an atmosphere containing hydrogen and nitrogen, the reaction rate increases as the heating reaction proceeds. The method for synthesizing ammonia according to the present embodiment preferably includes an activation step of heating the catalyst for ammonia synthesis according to the present embodiment, for example, in an atmosphere containing hydrogen or in hydrogen at 200° C. to 400° C. for 2 hours or more prior to the synthesis reaction of ammonia.

### EXAMPLES

The present invention will now be described in more detail with reference to examples. The ammonia synthesis activity was evaluated by determining the amount of NH₃ formed by a gas chromatograph or by determining the ammonia formation rate by determining the amount of NH₃ formed by dissolving the formed NH₃ in an aqueous sulfuric acid solution by an ion chromatograph.

(BET Specific Surface Area Measurement Method)

The BET specific surface area was measured from the adsorption and desorption isotherms with respect to the adsorption and desorption of nitrogen gas at −196° C. after the nitrogen gas was adsorbed on the surface of the object at the liquid nitrogen temperature. The analytical conditions were shown as follows.

[Measurement Conditions]

Measuring device: BELSORP-mini 2 (Microtract BEL), high-speed, specific surface/pore distribution measuring device

Adsorbed gas: nitrogen 99.99995 percent vol.

Adsorption Temperature: Liquid Nitrogen Temperature −196° C.

(Ion Chromatogram Analysis)

Ammonia gas discharged from the reaction vessel was dissolved in 5 mM sulfuric acid aqueous solution, and captured ammonium ions (NH⁴⁺) were analyzed by ion chromatography. The analytical conditions were shown as follows.

[Measurement Conditions]

Equipment: PU-2080 plus manufactured by JASCO

Detector: Conductivity detector CD −200 (manufactured by Shodex)

Column: Column LC-2000 plus (Japan Spectroscopy Co., Ltd.) for ion chromatogram Eluent: 4.0 mM methanesulfonic acid aqueous solution

Flow rate: 1.0 mL/min

Column temperature: 40° C.

### Example 1

(Preparation of Catalyst for Ammonia Synthesis)

0.007 g of BaF₂ powder (manufactured by Fujifilm Wako Pure Chemical Industries, Ltd., purity 99.9% by mass, average particle size 1.0 μm) and 0.081 g of CaH₂ powder (manufactured by Aldrich, 99.9% by mass purity, average particle size 0.5 μm) were physically mixed in a glove box under Ar atmosphere. A mixture of CaH₂ and BaF₂ (98CaH₂-2BaF₂) containing 2 mol % BaF₂ as a support was prepared. Further, 0.049 g of Ru (acac)₂ powder (manufactured by Aldrich, 99.7 wt % purity) was physically mixed with the mixture 98CaH₂-2BaF₂, sealed in a quartz glass tube, and heated at 260° C. for 2 hours and at 340° C. for 10 hours under a hydrogen gas atmosphere. As a result, a catalyst for ammonia synthesis in which 12% by mass of metal Ru was supported on 98CaH₂-2BaF₂ (hereinafter, 12 wt % Ru/98CaH₂-2BaF₂) was obtained. The BET surface area of the catalyst for ammonia synthesis was 30 m²/g. In the following, ammonia synthesis was carried out using the catalyst for ammonia synthesis.

In the present embodiment, “physically mix” means mixing using an agate mortar.

In the catalyst for ammonia synthesis after the above-mentioned “heating at 260° C. for 2 hours and at 340° C. for 10 hours in a hydrogen gas atmosphere” treatment in this Example, the support has a component different from that of “a mixture of CaH₂ and BaF₂ containing BaF₂” before the heating treatment (see Example 6 below). However, in order to avoid the complication of the description, the term “98CaH₂-2BaF₂” is used in the same manner as before the heating step. The same applies to Examples 2 to 5.

(Ammonia Synthesis Reaction)

Nitrogen gas (N₂) and hydrogen gas (H₂) were reacted on a catalyst to form ammonia (NH₃) (Ammonia synthesis reaction). The catalyst for ammonia synthesis 0.1 g was packed in a glass tube, and the ammonia synthesis reaction was carried out in a fixed bed flow type reactor. The water content of the raw gas was less than 1 ppm. The flow rate of the raw material gas was set at N₂:15 mL/min; H₂:for 45 mL/min, total 60 mL/min, pressure was 0.1 MPa, and reaction temperature was 340° C.

(Rate of Formation of Ammonia)

The gas coming out of the fixed bed flow type reactor was bubbled into a 0.005 M sulfuric acid aqueous solution, and ammonia in the gas was dissolved. The produced ammonium ion was determined by the ion chromatograph by the above method. The rates of formation ammonia at 340° C. for 1 hour, 25 hours, and 50 hours were 14.0 mmol g⁻¹ h⁻¹, 14.5 mmol g⁻¹ h⁻¹, and 14.8 mmol g⁻¹ h⁻¹, respectively. The results are shown in Table 1.

(Long-Term Stability of Catalyst)

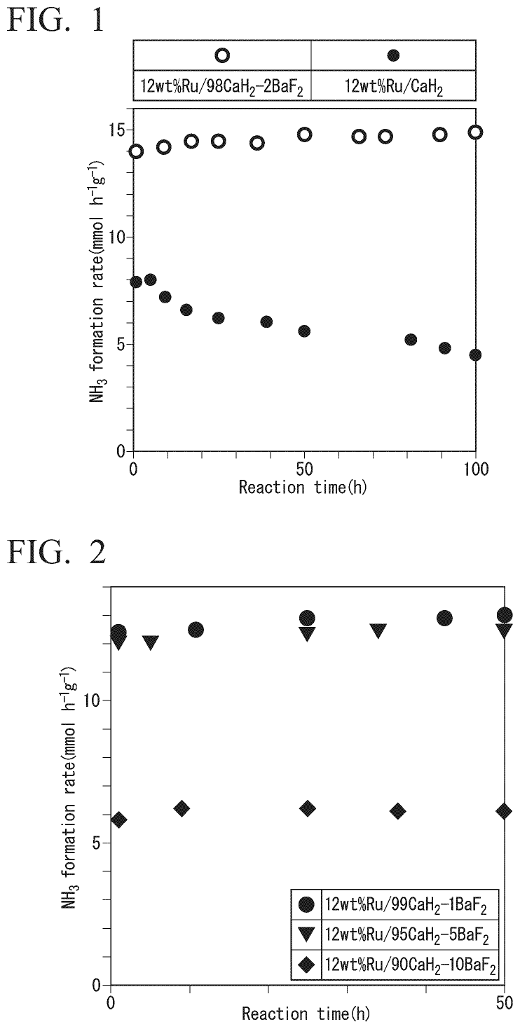

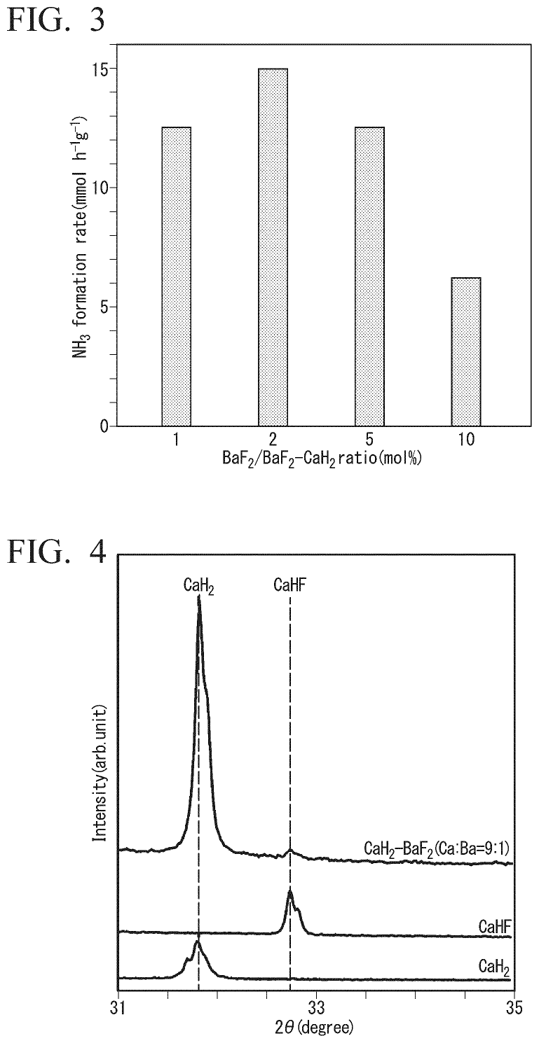

Using the catalyst for ammonia synthesis of the present Example, the ammonia synthesis reaction was carried out continuously for 100 hours to evaluate the long-term stability of the catalyst. FIG. 1 shows the results. It was found that the catalyst of the present embodiment stably produces ammonia in the reaction for 100 hours, and the reaction activity unlikely decreases.

### Example 2

(Preparation of Catalyst for Ammonia Synthesis)

A catalyst for ammonia synthesis in which 12% by mass of metal Ru was supported on 99CaH₂-1BaF₂ (hereinafter, 12 wt % Ru/99CaH₂-1BaF₂) was obtained by the same method as in Example 1, except that 98CaH₂-2BaF₂ containing 2 mol % BaF₂ in Example 1 was replaced by 99CaH₂-1BaF₂ containing 1 mol % BaF₂.

(Ammonia Synthesis Reaction)

A reaction for synthesizing ammonia (NH₃) (ammonia synthesis reaction) was carried out in the same manner and under the same conditions as in Example 1, except that 12 wt % Ru/98CaH₂-2BaF₂ in Example 1 was replaced by 12 wt % Ru/99CaH₂-1BaF₂.

(Rate of Formation of Ammonia)

The formation rate of ammonia at 340° C. was measured in the same manner as in Example 1. The rates of formation ammonia at 340° C. for 1 hour, 25 hours, and 50 hours were 12.4 mmol g⁻¹ h⁻¹, 12.9 mmol g⁻¹ h⁻¹, and 13.0 mmol g⁻¹ h⁻¹, respectively. The results are shown in Table 1.

(Long-Term Stability of Catalyst)

The ammonia synthesis reaction was carried out continuously for 50 hours using the catalyst for ammonia synthesis of the present embodiment, and the long-term stability of the catalyst was evaluated. FIG. 2 shows the results. It was found that the catalyst of the present embodiment stably produces ammonia in the reaction for 50 hours, and the reaction activity unlikely decreases.

### Example 3

(Preparation of Catalyst for Ammonia Synthesis)

A catalyst for ammonia synthesis in which 12% by mass of metal Ru was supported on 95CaH₂-5BaF₂ (hereinafter, 12 wt % Ru/95CaH₂-5BaF₂) was obtained by the same method as in Example 1, except that 98CaH₂-2BaF₂ containing 2 mol % BaF₂ in Example 1 was replaced by Ru/95CaH₂-5BaF₂ containing 5 mol % BaF₂.

(Ammonia Synthesis Reaction)

A reaction for synthesizing ammonia (NH₃) (ammonia synthesis reaction) was carried out in the same manner and under the same conditions as in Example 1, except that 12wt % Ru/98CaH₂-2BaF₂ in Example 1 was replaced by 12 wt % Ru/95CaH₂-5BaF₂.

(Formation Rate of Ammonia)

The formation rate of ammonia at 340° C. was measured in the same manner as in Example 1. The rates of formation ammonia at 340° C. for 1 hour, 25 hours, and 50 hours were 12.1 mmol g⁻¹ h⁻¹, 12.4 mmol g⁻¹ h⁻¹, and 12.5 mmol g⁻¹ h⁻¹, respectively. The results are shown in Table 1.

(Long-Term Stability of Catalyst)

The ammonia synthesis reaction was carried out continuously for 50 hours using the catalyst for ammonia synthesis of the present embodiment, and the long-term stability of the catalyst was evaluated. FIG. 2 shows the results. It was found that the catalyst of the present embodiment stably produces ammonia in the reaction for 50 hours, and the reaction activity unlikely decreases.

### Example 4

(Preparation of Catalyst for Ammonia Synthesis)

A catalyst for ammonia synthesis in which in which 12% by mass of metal Ru was supported on 90CaH₂-10BaF₂ (hereinafter, 12 wt % Ru/90CaH₂-10BaF₂) was obtained in the same manner as in Example 1, except that 98CaH₂-2BaF₂ containing 2 mol % BaF₂ in Example 1 was replaced by 90CaH₂-10BaF₂ containing 10 mol % BaF₂.

(Ammonia Synthesis Reaction)

A reaction for synthesizing ammonia (NH₃) (ammonia synthesis reaction) was carried out in the same manner and under the same conditions as in Example 1, except that 12 wt % Ru/98CaH₂-2BaF₂ in Example 1 was replaced by 12 wt % Ru/90CaH₂-10BaF₂.

(Rate of Formation of Ammonia)

The formation rate of ammonia at 340° C. was measured in the same manner as in Example 1. The rates of formation ammonia at 340° C. for 1 hour, 25 hours, and 50 hours were 5.8 mmol g⁻¹ h⁻¹, 6.2 mmol g⁻¹ h⁻¹, and 6.1 mmol g⁻¹ h⁻¹, respectively. The results are shown in Table 1.

(Long-Term Stability of Catalyst)

The ammonia synthesis reaction was carried out continuously for 50 hours using the catalyst for ammonia synthesis of the present embodiment, and the long-term stability of the catalyst was evaluated. FIG. 2 shows the results. It was found that the catalyst of the present embodiment stably produces ammonia in the reaction for 50 hours, and the reaction activity unlikely decreases.

### Example 5

(Preparation of Catalyst for Ammonia Synthesis)

In the same manner as in Example 1, 12 wt % Ru/98CaH₂-2BaF₂ having 12% by mass of metal Ru supported on 98CaH₂-2BaF₂ was obtained.

(Ammonia Synthesis Reaction)

Reactions for synthesizing ammonia (NH₃) (ammonia synthesis reaction) were carried out in a temperature range from 200° C. to 340° C. by the same method and conditions as in Example 1. In the ammonia synthesis reaction at each temperature, the catalysts subjected to the ammonia synthesis reaction at 340° C. for 50 hours was cooled to room temperature under nitrogen flow (60 mL/min), maintained at room temperature for 5 hours, and then the catalysts were heated to each target temperature under nitrogen gas and hydrogen gas flow (N₂:15 mL/min, H₂:45 mL/min).

(Rate of Formation of Ammonia at Each Temperature)

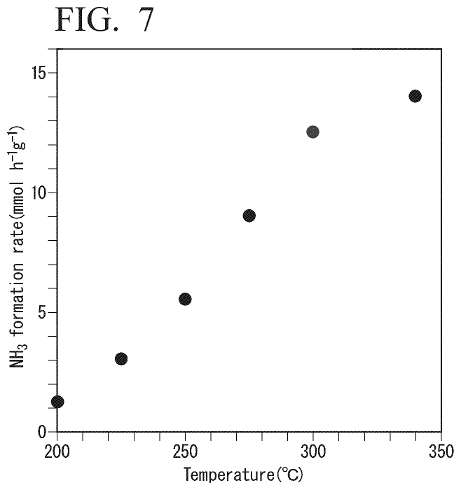

The formation rate of ammonia at each reaction temperature was measured by the same method as in Example 1. The rate of ammonia formation at each temperature is shown in FIG. 7.

(Long-Term Stability of Catalyst)

Using the catalyst for ammonia synthesis of Examples, the ammonia synthesis reaction was carried out continuously for 100 hours to evaluate the long-term stability of the catalyst. FIG. 1 shows the results. It was found that the catalyst of the present embodiment stably produces ammonia in the reaction for 100 hours, and the reaction activity unlikely decreases.

### Comparative Example 1

(Preparation of Catalyst for Ammonia Synthesis)

A catalyst for ammonia synthesis in which 12% by mass of metal Ru was supported on CaH₂ (hereinafter, 12 wt % Ru/CaH₂) was obtained by the same method as in Example 1, except that 98CaH₂-2BaF₂ in Example 1 was replaced by CaH₂ containing no BaF₂.

(Ammonia Synthesis Reaction)

A reaction for synthesizing ammonia (NH₃) (ammonia synthesis reaction) was carried out in the same manner and under the same conditions as in Example 1, except that 12 wt % Ru/98CaH₂-2BaF₂ in Example 1 was replaced by 12 wt % Ru/CaH₂.

(Rate of Formation of Ammonia)

The formation rate of ammonia at 340° C. was measured in the same manner as in Example 1. The rates of formation ammonia at 340° C. for 1 hour, 25 hours, and 50 hours were 7.9 mmol g⁻¹ h⁻¹, 6.2 mmol g⁻¹ h⁻¹, and 5.6 mmol g⁻¹ h⁻¹, respectively. The results are shown in Table 1.

(Long-Term Stability of Catalyst)

Ammonia synthesis was carried out continuously for 100 hours under the same reaction conditions using 12 wt % Ru/CaH₂ of Comparative Example as a catalyst, and the long-term stability of the catalyst was evaluated. FIG. 1 shows the results. It was found that the reaction activity of the catalyst of the Comparative Example was decreased up to 100 hours from the start.

### Example 6

(Preparation of 90CaH₂-10BaF₂)

As in Example 4, a mixture of CaH₂ and BaF₂ containing 10 mol % BaF₂ (hereafter, 90CaH₂-10BaF₂) was prepared as a support.

(XRD Measurement of Support Heated under Hydrogen Atmosphere)

XRD of the sample (FIG. 4: CaH₂-BaF₂ (Ca:Ba=9:1)) obtained by heat-treating the above 90CaH₂-10BaF₂ under hydrogen atmosphere was measured. The results are shown in FIG. 4. For comparison, CaF₂ (made by Kanto Chemical, purity 98.0%) and CaH₂ (Made by Aldrich, 99.9% pure) were heat-reacted at 550° C. for 10 hours under an Ar atmosphere, and XRD of the prepared CaFH solid solution was measured, and the results are shown in FIG. 4. It was found that CaFH was formed as F ion-substituted metal hydride by heat treatment of 90CaH₂-10BaF₂ under hydrogen atmosphere.

(Heat Treatment Conditions: 340° C., 10 Hours)

XRD measurement conditions: equipment (Bruker, D8ADVANCE), X-ray (Cu Kα, 45 kV, 360 mA)

(Structural Change of Support Heated under Hydrogen Atmosphere)

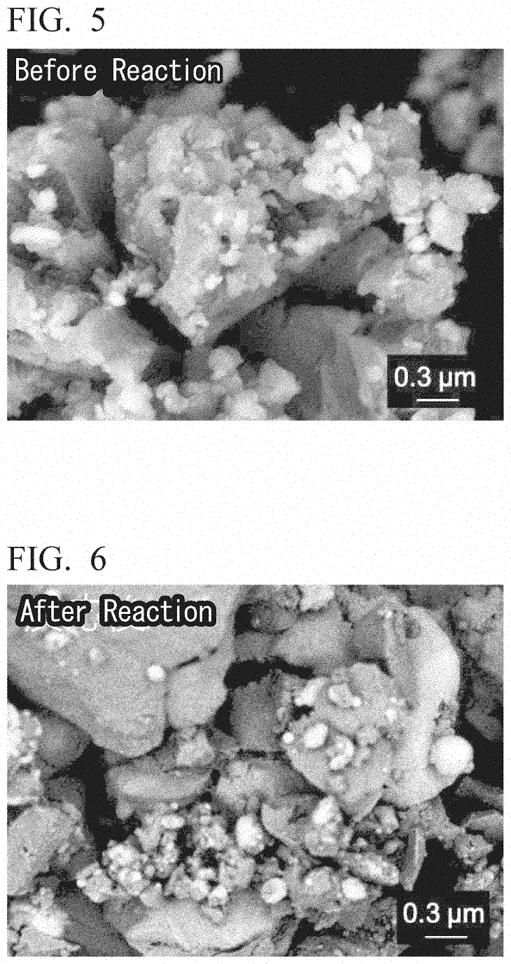

The structural change of the 90CaH₂-10BaF₂ support before and after the heat treatment under hydrogen atmosphere was observed. SEM electron microscope (SEM) photographs are shown in FIGS. 5 and 6.

TABLE 1

| | | Reaction | NH₃ |
|---|---|---|---|
| | | Time | Formation Rate |
| | Catalyst | (h) | (mmol g⁻¹ h⁻¹) |
| Example 1 | 12 wt % Ru/98CaH₂—2BaF₂ | 1 | 14.0 |
| | | 25 | 14.5 |
| | | 50 | 14.8 |
| Example 2 | 12 wt % Ru/99CaH₂—1BaF₂ | 1 | 12.4 |
| | | 25 | 12.9 |
| | | 50 | 13.0 |
| Example 3 | 12 wt % Ru/95CaH₂—5BaF₂ | 1 | 12.1 |
| | | 25 | 12.4 |
| | | 50 | 12.5 |
| Example 4 | 12 wt % Ru/90CaH₂—10BaF₂ | 1 | 5.8 |
| | | 25 | 6.2 |
| | | 50 | 6.1 |
| Comparative | 12 wt % Ru/CaH₂ | 1 | 7.9 |
| Example 1 | | 25 | 6.2 |
| | | 50 | 5.6 |

The effect of the catalyst for ammonia synthesis of the present invention may be explained by using an action which is caused by the dynamic function of the hydride ion (H⁻ ion). The hydride ion is contained in the F ion-substituted metal hydride such as calcium fluoride hydride: CaFH. The F ion-substituted metal hydride is formed by thermal reaction between a metal hydride such as CaH₂ and the alkaline earth metal fluoride. That is, when the catalyst for ammonia synthesis in which a transition metal such as Ru is supported on the metal hydride is heated, H⁻ ions in the catalyst for ammonia synthesis are released as a neutral hydrogen atom. At the defective site, an F center which has an electron is generated. For example, in the case where the metal hydride is CaH₂, since the valence of Ca in the formed CaFH is +2, the metal hydride has a larger lattice energy than an ion crystal of an alkali metal or the like. An hydride ion is also characterized in that its ionic radius can change with the environment. Therefore, when the hydride ion is replaced with the electron, the energy level of the electron of the F center in CaFH may be kept at a high level without drastically lowering by the relaxation of the structure around the F center. As a result, a work function of CaFH decrease during hydrogen release. Therefore, the electron donation to the supported metal species can improve the catalytic activity of the metal species. And a Ca—H bond energy is significantly smaller than a Ca—F bond energy. Therefore, the Ca—H bond energy in CaFH is smaller than that in CaH₂. That is, the release temperature of the neutral hydrogen in CaFH is lower than that in CaH₂. By lowering the release temperature of the neutral hydrogen, CaFH may show an electron donating effect to the metal species at a temperature lower than that of CaH₂.

1. A catalyst for ammonia synthesis, comprising:
a metal supported material which comprises
a transition metal, and
a support for supporting the transition metal,
wherein the support comprises:
a metal hydride represented by the following general formula (1), and an F ion,
XHₙ (1)
wherein in the general formula (1), X represents at least one kind selected from the group consisting of atoms of Group 2 of the periodic table, atoms of Group 3 of the periodic table, and lanthanoid atoms; and n represents a number represented by 2≤n≤3.

2. The catalyst for ammonia synthesis according to claim 1,
wherein the support comprises an F ion-substituted metal hydride obtained by substituting at least a part of a hydrogen anion of the metal hydride with an F ion.

3. The catalyst for ammonia synthesis according to claim 1,
wherein the support comprises
the metal hydride, and
a metal fluoride represented by the following general formula (2),
YFₘ (2)
wherein in the general formula (2), Y represents at least one kind selected from the group consisting of atoms of Group 2 of the periodic table, atoms of Group 3 of the periodic table, and lanthanoid atoms; and m represents a number represented by 2≤m≤3.

4. The catalyst for ammonia synthesis according to claim 3,
wherein Y in the general formula (2) is at least one selected from the group consisting of Mg, Ca, Sr, Ba, Sc, Y, and lanthanoid atoms.

5. The catalyst for ammonia synthesis according to claim 1,
wherein X in the general formula (1) is at least one selected from the group consisting of Mg, Ca, Sr, Ba, Sc, Y, and lanthanoid atoms.

6. The catalyst for ammonia synthesis according to claim 1,
wherein the transition metal is at least one selected from the group consisting of Ru, Co, and Fe.

7. The catalyst for ammonia synthesis according to claim 1,
wherein an amount of the transition metal supported on the support is 1.0% by mass or more and 30% by mass or less.

8. The catalyst for ammonia synthesis according to claim 1,
wherein an amount of the F ion with respect to the total mole number of the metal hydride and the F ion is 0.5 mol % or more and 20 mol % or less.

9. A method for synthesizing ammonia, the method comprising:
bringing a raw material gas containing hydrogen and nitrogen into contact with the catalyst according to claim 1 to synthesize ammonia.

10. The method for synthesizing ammonia according to claim 9,
wherein a reaction temperature in contact with the catalyst for ammonia synthesis is 200° C. or more and 600° C. or less.

11. The method for synthesizing ammonia according to claim 9,
wherein a reaction pressure in contact with the catalyst for ammonia synthesis is 10 kPa or more and 20 MPa or less.

12. The method for synthesizing ammonia according to claim 9,
wherein a water content of the raw material gas is 100 ppm or less.

13. The method for synthesizing ammonia according to claim 9,
wherein a ratio of hydrogen to nitrogen (H₂/N₂ (volume/volume)) in contact with the catalyst for ammonia synthesis is 0.4 or more.
